(19) United States
(12) Patent Application Publication
(10) Pub. No.: US 2016/0300240 A1
(43) Pub. Date: Oct. 13, 2016

(54) SENSOR-BASED NFC/RF MECHANISM WITH MULTIPLE VALID STATES FOR DETECTING AN OPEN OR COMPROMISED CONTAINER, AND METHODS OF MAKING AND USING THE SAME

(71) Applicants: Matthew BRIGHT, San Jose, CA (US); Jennifer ERNST, Union City, CA (US); Christer KARLSSON, Linkoping (SE); Lars HERLOGSSON, Linkoping (SE)

(72) Inventors: Matthew BRIGHT, San Jose, CA (US); Jennifer ERNST, Union City, CA (US); Christer KARLSSON, Linkoping (SE); Lars HERLOGSSON, Linkoping (SE)

(73) Assignee: Thin Film Electronics ASA, Oslo (NO)

(21) Appl. No.: 15/094,946

(22) Filed: Apr. 8, 2016

Related U.S. Application Data
(60) Provisional application No. 62/146,105, filed on Apr. 10, 2015.

(51) Int. Cl. G06Q 30/00; G01N 27/414; G06K 7/10

(52) U.S. Cl. CPC G06Q 30/018; G06K 7/10316; G06K 7/10297; G01N 27/4148

(57) ABSTRACT

A wireless (e.g., near field or RF) communication device, and methods of manufacturing and using the same are disclosed. The wireless communication device includes a receiver and/or transmitter, a substrate with an antenna thereon, an integrated circuit, and one or more continuity sensors. The antenna receives and/or transmits or broadcasts a wireless signal. The integrated circuit processes the wireless signal and/or information therefrom, and/or generates the wireless signal and/or information therefor. The continuity sensor(s) are configured to sense or determine the presence of a chemical or substance in the package or container, and thus a continuity state of a package or container on which the communication device is placed or to which the communication device is fixed or adhered. The continuity sensor(s) are electrically connected to a set of terminals of the integrated circuit different from the set of terminals to which the antenna is electrically connected.

### CROSS REFERENCE TO RELATED APPLICATION

This application claims the benefit of U.S. Provisional Patent Application No. 62/146,105, filed on Apr. 10, 2015, incorporated herein by reference as if fully set forth herein.

### FIELD OF THE INVENTION

The present invention generally relates to the field(s) of near field and radio frequency communication. More specifically, embodiments of the present invention pertain to radio frequency (RF and/or RFID), near field communication (NFC), high frequency (HF) and ultra high frequency (UHF) tags and devices with a sensor-based mechanism for detecting an open or compromised container while preserving the ability of the tags and devices to communicate wirelessly, and methods of manufacturing and using the same.

### DISCUSSION OF THE BACKGROUND

Counterfeiting and diversion (sale of a product outside authorized regions or distributors, also known as ‘gray market activity’) are two common problems impacting global supply chains and global brands. Apart from the obvious loss of revenue from the sale of genuine products, brands are negatively impacted by counterfeiting when an unknowing consumer loses confidence in a product's quality or safety. In the case of gray market activity, the brand company might receive revenue for the sale of genuine product in an area where it is not distributed, but the unauthorized sales could compromise country- and region-specific pricing. In addition, taxing authorities might not be properly reimbursed if product is sold outside the intended region. This potential loss of revenue makes governments stakeholders, as well.

Product manufacturers often turn to different technology to protect against counterfeiting and diversion. Holograms are very common and can be read in the field, but are increasingly easy to forge. Sophisticated ‘forensic’ types of verification generally require shipment of questionable product to a certified lab for analysis and verification, meaning that it such methods cannot be used for real-time, in-field analysis and decision making.

In order to overcome the limitations of holograms and enhance the level of security while preserving the ability to verify authenticity in the field (for example, at customs inspection, at a retail store, in a restaurant), manufacturers of certain products, including pharmaceuticals, premium products such as alcoholic beverages and potentially tobacco, premium fragrances, and cosmetics, look to wireless solutions that combine RFID tags with reader devices. One particularly convenient implementation—due to the wide availability of NFC-capable smartphones (500 million in use by 2014 and 1 billion to be sold worldwide from 2014 and 2015)—combines NFC (13.56 MHz High Frequency [HF] RFID) tags with NFC-capable smartphones. In this implementation, NFC tags are placed in such a way that opening the protected product destroys the NFC tag, generally by breaking the antenna in some way (for example, poking the antenna with a corkscrew or twisting and breaking the antenna in the act of opening a screw-top container). This means that cloud services that authenticate protected items based on the NFC tag's ID cannot be used after the protected item has been opened.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to near field communication (NFC) and radio frequency (RF and/or RFID) tags and devices with a sensor-based mechanism for detecting or sensing the presence of one or more contents of a container in the environment outside the container (e.g., an open, damaged or otherwise compromised container) that also preserves the ability of the tags and devices to communicate wirelessly after the container is opened, and methods of manufacturing and using the same. For example, the mechanism for detecting whether a package is sealed or open is not determined by a tear in the packaging or break in the antenna, but rather, it is determined by a (chemical) sensor. In particular, a portion of a trace or an open space in a trace, filled by a material that becomes more or less conductive based on exposure to a given substance or chemical of the product inside the packaging, can be used to form a sensor that can sense or detect whether a package to which the NFC tag is attached has been opened by determining the presence of a threshold amount or concentration of one or more contents inside the container or package. In NFC sensor-based detection, the continuity of the trace (or lack thereof) can be determined from a sensor-triggered connection which is independent of the antenna and integrated circuit (IC) portion of the tag. In the present invention, the NFC reader and IC can communicate at all times with the antenna, independent of the (chemical-based) continuity of the trace. Thus, the detection in the environment immediately outside the container of one or more contents (e.g., chemicals, substances or materials) intended to be inside the container can indicate an open or damaged (e.g., broken or cracked) container.

In one aspect, the present invention relates to a wireless (e.g., near field or RF) communication device, comprising a receiver and/or transmitter, a substrate with an antenna thereon, an integrated circuit, and one or more continuity sensors. The antenna receives and/or transmits or broadcasts a wireless signal. The integrated circuit processes (i) the wireless signal and/or information therefrom and/or (ii) generates the wireless signal and/or information therefor. The integrated circuit has a first set of terminals electrically connected to the antenna. The continuity sensor(s) are on a common or different substrate as the antenna. The continuity sensor(s) sense or determine the presence of a material (e.g., a chemical or substance) that is in a package or container on which the wireless communication device is placed or to which the wireless communication device is fixed or adhered. Thus, the continuity sensor(s) sense or determine a continuity state of the package or container. The continuity sensor(s) are electrically connected to a second set of terminals of the integrated circuit different from the first set of terminals.

In some embodiments, the continuity sensor(s) comprise a trace with a section therein including a material having a conductance or resistivity that changes based on exposure to a chemical or substance inside the package or container. For example, the continuity sensor(s) may comprise (i) a voltage corresponding to high digital logic state (or a voltage source providing such a voltage) electrically coupled to an end of at least one of the continuity sensor(s), and (ii) a pull-down circuit that drives an output node of the at least one continuity sensor to a logic low state when the conductance or resistivity of the at least one continuity sensor changes to indicate exposure to the chemical or substance inside the package or container.

In some alternative embodiments, the continuity sensor(s) comprise a transistor with a gate or base including a material having a conductance or resistivity that changes based on exposure to a chemical or substance inside the package or container. For example, the continuity sensor(s) may comprise (i) a voltage corresponding to high digital logic state (or a voltage source providing such a voltage) electrically coupled to a first source/drain or collector/emitter terminal of the transistor, and (ii) a pull-down circuit electrically coupled to a second source/drain or collector/emitter terminal of the transistor, configured to drive an output node of the continuity sensor(s) to a logic low state when the conductance or resistivity of the gate or base changes to indicate exposure to the chemical or substance inside the package or container. In some examples, the pull-down circuit comprises a resistor or resistor-wired transistor connected at one terminal to the output node of the one continuity sensor, and at an opposite terminal to a ground voltage.

In some embodiments, the integrated circuit further comprises a second sensor, one or more redundant continuity sensors, a threshold comparator receiving an output of the continuity sensor(s), and/or a memory. The second sensor may comprise a temperature sensor, a humidity sensor, an electromagnetic field sensor, a current, voltage and/or power sensor, a light sensor, or a second chemical and/or continuity sensor, and may be electrically connected to the integrated circuit at a third set of terminals different from the first and second sets of terminals. The memory includes one or more bits configured to store a value corresponding to a continuity state of the container or package and/or an output of the threshold comparator. Alternatively or additionally, the memory may include a plurality of bits configured to store a unique identification code for the container or package.

In various embodiments, the integrated circuit comprises one or more printed layers (e.g., a plurality of printed layers) and/or one or more thin films (e.g., a plurality of thin films). For example, the integrated circuit may comprise one or more thin films and one or more printed layers. Alternatively, the integrated circuit may be or comprise an “all-printed” integrated circuit. In some examples, the antenna consists of a single metal layer.

The wireless communication device may be or comprise a near field and/or radio frequency communication device, and may comprise the transmitter, the receiver, or both. When the wireless communication device comprises the transmitter, the transmitter may comprise a modulator. When the wireless communication device comprises the receiver, the receiver may comprise a demodulator.

In various embodiments, the substrate may comprise a plate, disc and/or sheet of a glass, ceramic, dielectric and/or plastic. Alternatively, the substrate may comprise a flexible metal foil having a diffusion barrier layer thereon and an oxide layer or other electrical insulator on the diffusion barrier layer.

The invention also contemplates a package or container and the wireless communication device. The package or container has first and second separable parts with an interface therein (e.g., between first and second separable parts), and the wireless communication device is on one of the first and second separable parts of the package or container, near the interface. For example, the first separable part of the package or container may comprise a box, tray, bottle, container or jar, and the second separable part may comprise a cap, sealing material or lid corresponding to, adhered to and/or configured to mate with the box, tray, bottle, container or jar. Alternatively, the first and second separable parts of the package or container may comprise first and second flaps on a box (e.g., that can be sealed using packaging tape or other tape), or a tray or carton and a corresponding lid. The first and second separable parts of the package or container can also be the flap and the back of an envelope or other thin, relatively flat shipping container. The integrated circuit, the antenna, and the one or more sensors are generally on the first separable part of the package or container, although they can also be on the second separable part of the package or container.

In general, the continuity sensor(s) are configured to determine a presence of a chemical or substance in the package or container. The package or container is considered open when the continuity sensor(s) determine the presence of the chemical or substance, and the package or container is considered sealed when the continuity sensor(s) do not determine the presence of the chemical or substance.

In another aspect, the present invention relates to a method of manufacturing a wireless (e.g., near field or RF) communication device, comprising forming an antenna on a first substrate, forming one or more continuity sensors (e.g., as described herein) on a common or different substrate, forming an integrated circuit on a substrate common with at least one of the antenna and the continuity sensor(s) or different from each of the antenna and the continuity sensor(s), and electrically connecting the antenna to a first set of terminals of the integrated circuit, and the continuity sensor(s) to a second terminal or set of terminals of the integrated circuit. The antenna is configured to receive and/or transmit or broadcast a wireless signal. In some embodiments, the wireless communication device comprises a near field and/or radio frequency communication device.

In further embodiments, the method may further comprise forming a trace in the continuity sensor(s). The trace may have a section therein including a material having a conductance or resistivity that changes based on exposure to a chemical or substance inside the package or container. In other embodiments, the continuity sensor(s) may comprise (i) a voltage corresponding to high digital logic state (or a voltage source providing such a voltage) electrically coupled to an end of one continuity sensor, and (ii) a pull-down circuit that drives an output node of the one continuity sensor to a logic low state when the conductance or resistivity of the one continuity sensor changes to indicate exposure to the chemical or substance inside the package or container.

In an alternative embodiment, the method may further comprise forming a transistor in the continuity sensor(s). The transistor may have a gate or base including a material having a conductance or resistivity that changes based on exposure to a chemical or substance inside the package or container. The continuity sensor(s) may comprise (i) a voltage corresponding to high digital logic state (or a voltage source providing such a voltage) electrically coupled to a first source/drain or collector/emitter terminal of the transistor, and (ii) a pull-down circuit electrically coupled to a second source/drain or collector/emitter terminal of the transistor, configured to drive an output node of the continuity sensor(s) to a logic low state when the conductance or resistivity of the gate or base changes to indicate exposure to the chemical or substance inside the package or container. In some embodiments, the pull-down circuit comprises a resistor or resistor-wired transistor connected at one terminal to the output node of the continuity sensor, and at an opposite terminal to a ground voltage.

The method may, in some cases, further comprise forming one or more redundant continuity sensors. In some embodiments, the redundant continuity sensor(s) may be formed on the same substrate (and on the same side or surface of the same substrate) as the continuity sensor(s).

In various further or alternative embodiments, forming the integrated circuit may comprise printing one or more layers of the integrated circuit. For example, the method may comprise printing a plurality of the layers of the integrated circuit. Alternatively or additionally, forming the integrated circuit may comprise forming a plurality of layers of the integrated circuit by one or more thin film processing techniques. In some examples, forming the integrated circuit may comprise forming one or more layers of the integrated circuit by one or more thin film processing techniques, and printing one or more additional layers of the integrated circuit.

In some embodiments, forming the antenna consists of forming a single metal layer on the first substrate, and etching the single metal layer to form the antenna. Alternatively, forming the antenna may comprise printing a metal ink on the first substrate in a pattern corresponding to the antenna.

In further embodiments, the wireless communication device further comprises an additional sensor, and the method further comprises electrically connecting the additional sensor to a third set of terminals on the integrated circuit different from the first and second sets of terminals. Additionally or alternatively, the integrated circuit may further comprise a threshold comparator receiving an output of one of the continuity sensor(s), and the method may further comprise forming the threshold comparator (e.g., by printing and/or thin film processing, as described herein).

In various embodiments, the integrated circuit further comprises a memory including one or more bits configured to store a value corresponding to a continuity state of the container or package, and the method may further comprise forming the memory (e.g., by printing and/or thin film processing, as described herein). In some examples, the memory further includes a plurality of bits configured to store a unique identification code for the container or package. For example, the memory may be formed by printing at least one layer of the memory that includes the plurality of bits configured to store the unique identification code for the container or package.

In a still further aspect, the present invention relates to a method of detecting an opened or compromised package or container, comprising placing a wireless communication device comprising an antenna, one or more continuity sensors, and an integrated circuit on the package or container such that the continuity sensor(s) are sufficiently close to an interface between first and second separable parts of the package or container to detect a substance or chemical within the package or container if the package or container is opened. The integrated circuit is electrically connected to each of the antenna and the continuity sensor(s). The method further comprises determining whether the substance or chemical is present outside the package or container using the integrated circuit. In some embodiments, the wireless communication device comprises a near field and/or radio frequency communication device. In general, the continuity sensor(s) comprises a trace having a section therein including a material having a conductance or resistivity that changes based on exposure to a chemical or substance inside the package or container.

In some embodiments of the method of detecting an opened or compromised package or container, the continuity sensor(s) comprises (i) a voltage corresponding to a high digital logic state (or a voltage source providing such a voltage) electrically coupled to an end of one of the continuity sensor(s), and (ii) a pull-down circuit that drives an output node of the one continuity sensor to a logic low state when the conductance or resistivity of the one continuity sensor changes to indicate exposure to the chemical or substance inside the package or container. In one example, the continuity sensor(s) comprise a transistor having a gate or base including a material having a conductance or resistivity that changes based on exposure to a chemical or substance inside the package or container. Alternatively, the continuity sensor(s) comprise (i) a voltage corresponding to high digital logic state (or a voltage source providing such a voltage) electrically coupled to a first source/drain or collector/emitter terminal of the transistor, and (ii) a pull-down circuit electrically coupled to a second source/drain or collector/emitter terminal of the transistor, configured to drive an output node of the continuity sensor(s) to a logic low state when the conductance or resistivity of the gate or base changes to indicate exposure to the chemical or substance inside the package or container. In some embodiments, the pull-down circuit comprises a resistor or resistor-wired transistor connected at one terminal to the output node of the one continuity sensor, and at an opposite terminal to a ground voltage.

In some embodiments of the method of detecting an opened or compromised package or container, the wireless communication device further comprises one or more redundant continuity sensors. Alternatively or additionally, the integrated circuit may further comprise an additional sensor electrically connected to the integrated circuit (e.g., at a third set of terminals different from the first and second sets of terminals).

In various embodiments, the integrated circuit may comprise one or more printed layers and/or a plurality of thin films. In one example, the antenna consists of single metal layer, and the integrated circuit may be placed over the antenna in a manner that electrically connects at least two ends of the antenna to the integrated circuit.

As for other aspects of the present invention, in some embodiments, the integrated circuit further comprises a threshold comparator receiving an output of the continuity sensor(s). Additionally or alternatively, the integrated circuit may further comprise a memory including one or more bits configured to store a value corresponding to the continuity state of the container or package and/or a plurality of bits configured to store a unique identification code for the container or package. The memory may comprise at least one printed layer configured to store the unique identification code for the container or package.

In the method of detecting an opened or compromised package or container, the continuity state of the package or container may be “opened” when the continuity sensor(s) determine a presence of a chemical or substance in the package or container. Additionally or alternatively, the continuity state of the package or container may be “closed” or “sealed” when the continuity sensor(s) does not determine the presence of the chemical or substance.

As a result, the present invention may expand the use and functionality of near field communication and RF tags and devices. The novel tags and devices enable detection of an opened or compromised packaged or sealed product, along with continued use of the tags and devices to communicate information about the product in the container or package after the container or package has been opened. These and other advantages of the present invention will become readily apparent from the detailed description of various embodiments below.

### BRIEF DESCRIPTION OF THE DRAWINGS

FIG. 1 shows an exemplary NFC/RF tag with an exemplary continuity sensor circuit for sensing whether a container bearing the tag has been opened or compromised, in accordance with one or more embodiments of the present invention.

FIG. 2 shows an NFC/RF tag with an exemplary alternative continuity sensor circuit for sensing whether a container bearing the tag has been opened or compromised, in accordance with one or more embodiments of the present invention.

FIG. 3 shows an exemplary integrated circuit for use in the present NFC/RF tag.

FIG. 4 shows an alternative exemplary integrated circuit and sensor suitable for use in the present NFC/RF tag.

FIG. 5 shows a further alternative wireless tag with multiple sensors, suitable for use in the present invention.

FIG. 6 shows an exemplary communications network in which the present device and method may be used.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components and materials have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The present invention solves a problem in conventional solutions where the NFC tag cannot be read after the protected product is opened. The invention allows reading the tag (1) prior to opening the protected product (e.g., to verify that it has been unopened) and (2) after opening the product. Reading the tag after opening the product may trigger a different NFC user experience when the product is detected as having been opened. Product manufacturers, distributors, resellers, and consumers all have interest in the ability to read the tag after opening, for example, to access product recall notices, read product use instructions and marketing information, contact support or warranty services easily, re-order the product, or order related consumables or accessories.

The present invention may use a combination of ROM bits (typically as a unique ID) and one or more sensor bits, and contemplates sensing a state of a chemical sensor and/or an electrical connection made or broken by the chemical sensor as a state of the container and/or a form of “barcode”. When read by an NFC-capable smart phone or other reading device, the NFC and/or RFID tag's memory bit(s) allocated to sensor data will indicate whether the package is intact or broken.

Exemplary Wireless (e.g., NFC and/or RF) Device(s)

FIG. 1 shows an exemplary near field communication (NFC) and/or RF device 100 (e.g., an NFC tag) according to the present invention. The device generally comprises a substrate (not shown), an integrated circuit (IC) 110, an antenna 120 in communication with the IC, and one or more sensors 130 in separate communication with the IC 110. Optionally, the NFC device 100 can also have one or more redundant sensors in separate communication with the IC 110. This structure and/or device architecture is also applicable to radio frequency (RF) devices, such as RFID tags, high frequency (HF) devices such as roll readers, very high frequency (VHF) devices, ultra high frequency (UHF) devices, etc.

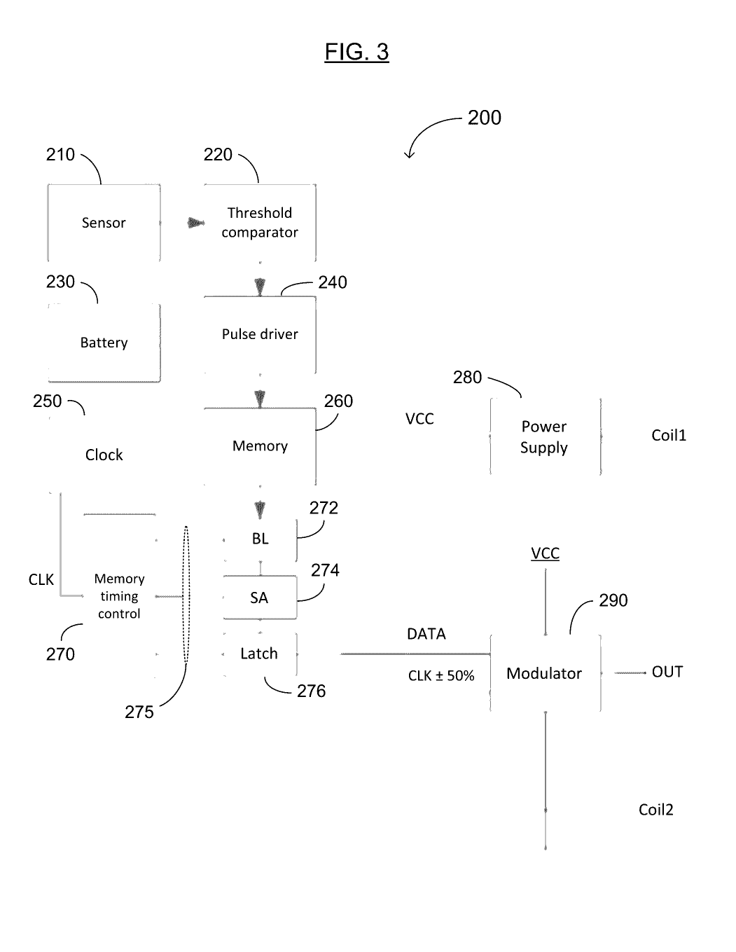

FIG. 3 shows an exemplary IC 200 suitable for use as the IC 110 in FIG. 1, which may include one or more sensors 210, a threshold comparator 220 receiving information (e.g., a signal) from the sensor 210, a pulse driver 240 receiving an output of the threshold comparator 220, a memory 260 storing sensor data from the pulse driver 240, one or more bit lines (BL) 272 for reading data from the memory 260, one or more sense amplifiers (SA) 274 for converting signal on the bit line(s) to digital signals, one or more latches 276 for temporarily storing data from the sense amplifier(s) 274, and a transmitter (e.g., modulator) 290 configured to output data (including identification code) from the device (e.g., the wireless communication device 100 in FIG. 1). The exemplary IC 200 in FIG. 3 also contains a clock circuit 250 configured to provide a timing signal (e.g., CLK) that controls the timing of certain operations in the IC 200 and a memory timing control block or circuit 270 that controls the timing of memory read operations. The modulator 290 also receives the timing signal (CLK) from the clock circuit 270, or a slowed-down or sped-up variation thereof. The exemplary IC 200 also includes a power supply block or circuit 280 that provides a direct current signal (e.g., VCC) to various circuits and/or circuit blocks in the IC 200. The memory 260 may also contain identification code. The portion of the memory 260 containing identification code may be printed. The IC 200 may further contain a receiver (e.g., a demodulator), one or more rectifiers (e.g., a rectifying diode, one or more half-bridge or full-bridge rectifiers, etc.), one or more tuning or storage capacitors, etc. Terminals in the modulator 290 and the power supply 280 are connected to ends of the antenna (e.g., at Coil1 and Coil2).

The present continuity sensor 130 shown in FIG. 1 includes a sensor material 132 and a leaker circuit 134. As shown in FIG. 1, one may simply connect the sensor 132 to a voltage corresponding to high digital logic state (e.g., an upper power rail [VCC] or other circuit element connected to a high voltage) in the sensor block 130, as well as to a (weak) pull-down or leaker circuit 134 that drives the input node 135 to the IC 110 to a logic low state when the sensor material 132 does not electrically connect the high voltage to the IC 110. The pull-down or leaker circuit 134 may be a resistor or resistor-wired transistor connected at an opposite terminal to a ground voltage. In such a design, no memory bits, and optionally no threshold comparator, are necessary. However, the memory 260 and threshold comparator 220 (FIG. 3) may be useful for embodiments that include additional sensors, identification code, etc.

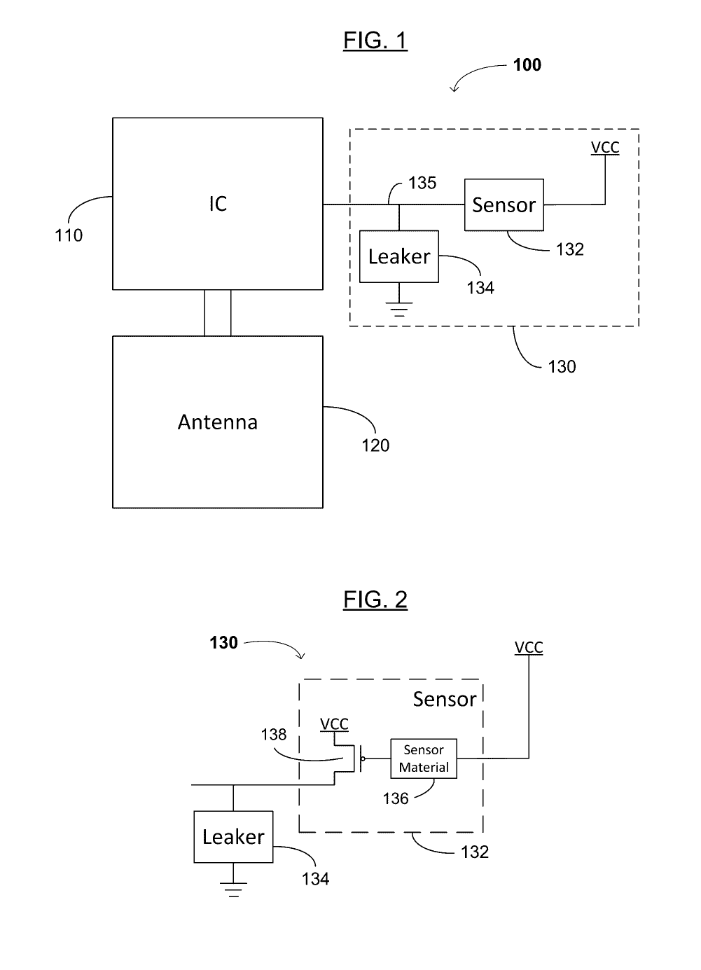

As shown in FIG. 1, the sensor 132 in the present tag may be or represent an open space in a trace filled with a material that becomes more or less conductive based on exposure to a given element or substance inside the package or container. A similar technique is used on certain wireless tags to enable or disable the antenna, but it results in one state always being unreadable (i.e., when the antenna is disabled). Moving the sensor material (e.g., 136 in FIG. 2) to the trace allows two or more valid states. In some embodiments, a transistor (e.g., receiving the sensor output at one source/drain or emitter/collector terminal and a “sensor enable” signal at the gate or base, or which can be diode-wired and receive the sensor signal at both a source/drain or emitter/collector terminal and at the gate or base) may modulate the signal from the sensor to the IC 110.

The sensor material 136 in such a case can be an electrolyte (for example, a dry gel electrolyte, the conductivity of which increases when exposed to water or water vapor that is absorbed by the electrolyte). The threshold(s) for the “exposed” state can be determined empirically (e.g., using dimensions of the trace, the proportion[s] of the material[s] whose conductivity changes as a function of exposure to the chemical, the current across the leaker circuit 134, etc.). In some embodiments, the conductance of the sensor material 136 changes nonlinearly with respect to a particular gas or chemical such as water, CO, etc. The sensor material(s) 136 in/on the NFC or other wireless tag must be exposed to the external environment to determine the “exposed/not exposed” state of the article to an environmental chemical. When the environmental chemical is a chemical that is also contained within the sealed article, and the conductance of the sensor material 136 changes when the concentration of the chemical is greater than that which would be found naturally in the environment surrounding the article, one can conclude that a change in the conductance of the sensor material 136 is caused by opening the article or otherwise breaking the seal.

As shown in FIG. 2, a non-linear element such as a transistor 138, in which a material parameter such as conductance depends on at least one environmental condition (e.g. humidity, temperature, presence or absence of a chemical [e.g., a gas or liquid]) can also be used in the sensor 132 to control or affect the value of the signal input to the IC 110. In various examples, the sensor 132 may comprise a non-linear transistor, the threshold voltage or conductivity of which changes upon absorption of the chemical (e.g., in a gate material thereof); a chemical sensor, the resistance of which changes upon absorption of the chemical; a membrane- or microelectromechanical system (MEMS)-based sensor, etc.

An example of a non-linear transistor the threshold voltage or conductivity of which changes upon absorption of the chemical is one that has an electrolyte in the gate that leads to a large signal swing in dry conditions as compared to humid conditions. When the gate comprises such an electrolyte, most or substantially all of the field is over the electrolyte (which works as dielectric under dry conditions), and thus an n-TFT including such an electrolyte in the gate is in the “off” state even when a voltage corresponding to an “on” state is applied to the gate. Under humid conditions, the electrolyte conducts, the field is over the gate dielectric, and the n-TFT is on upon application of an “on” voltage. In one example, a dry lithium polymer electrolyte (e.g., suitable for battery applications) may be printed (e.g., using a roll-to-roll [R2R] capable printing method) as the gate of such a transistor. The sensor 132 or sensor material 136 can be placed close to the cap, plug, cork or other seal of a container containing a liquid (e.g., water), and after the seal is broken, the electrolyte will absorb the liquid (e.g., water or water vapor). In one embodiment, the opening of the container can be designed to funnel or direct a small amount of the liquid (e.g., a sufficient amount to change the conductance state of the electrolyte) to the sensor 132 or sensor material 136. When the sensor 132 or sensor material 136 absorbs enough liquid to change its conductance state or value (e.g., its resistivity), the transistor 138 will conduct (or at least begin to conduct), and the state or value of the output signal from the sensor 132 will change. The composition, shape and dimensions of the gate may be optimized for on/off switching in a transistor. In an alternative embodiment, the lithium may be replaced with zinc ions, and/or the electrolyte may be another electrolyte suitable for battery applications (see, e.g., WO 2012/037171, published Mar. 22, 2012 and/or U.S. Pat. Appl. Publ. No. 2013/0280579, the relevant portions of which are incorporated herein by reference.)

Another example of a transistor the threshold voltage or conductivity of which changes upon absorption of the chemical is an ISFET (ion selective field effect transistor). Examples of a chemical sensor the resistance of which changes upon absorption of the chemical include nanowires, carbon nanotubes, and hydrogels and/or dry gels with water vapor sensitivity and/or a physical matrix that contains analyte-sensitive fluorophores or electrophores (e.g., an alcohol-sensitive fluorophore). More specific examples of chemical sensors the resistance or conductance of which changes upon absorption of the chemical include:
Analyte-sensitive fluorophores in sol-gel films;
Resistive gas sensors and chemiresistors;
Semiconductors and field effect devices (FEDs), such as FED Ion semiconductors, FED Gas semiconductors, and Schottky diodes whose conductance state changes upon the presence of a gas exceeding a threshold concentration and which may include one or more semiconductors;
Nanomaterials, such as metallic, carbon, polymer (e.g., dry lithium) and inorganic nanofibers; and magnetic or semiconducting nanomaterials.

Particularly useful electrolytes for use in the present invention include polymer electrolytes (i.e., an electrolyte that contains a salt that is dissolved in a solvating polymer matrix). Polyethylene oxide (PEO) is a good ion conductor, especially for protons and other small cations, and is often used in polymer electrolytes for this reason. The polymer can conduct or transport ions but is not itself conductive, so ions in the form of salts (e.g., lithium perchlorate, LiClO₄) are generally added. However, some electrolyte materials may be hygroscopic (e.g., PEO), so water from the surroundings absorbed by the hygroscopic electrolyte material(s) may dissociate (e.g., into H₃O⁺ and OH⁻ ions) and contribute to (ion) conductivity. The absorbed water can also have an effect on the ion mobility, and thus the ion conductivity, of the polymer electrolyte.

Other electrolytes suitable for use in the present invention include polyelectrolytes. Polyelectrolytes are polymeric or pseudo-polymeric materials that have ionic groups in a repeating unit, which means that one of the ions is bound to the polymer chain (i.e., is immobile) and the counter-ion is free to move (i.e., is mobile). Polyelectrolytes include polycations and polyanions, in which the mobile ion is an anion (−) or a cation (+), respectively. These types of materials are usually hygroscopic. Typically, they need water or another solvent that enables mobility of the mobile ion in order to dissociate. As a result, they are good candidates for use in humidity or water sensing applications.

When polyelectrolytes are dry, they contain few mobile ions (which may also have low mobility). The (ionic) resistance of the material is relatively high. When the water content increases, more ions become mobile, and the mobility of these ions generally also increases. In other words, the ionic conductivity increases. Polymer electrolytes, on the other hand, are often conductive when they are dry. However, the number of mobile charge carriers (ions) and the mobility of the ions can potentially increase with increased water content, thus also giving an increased ionic conductivity upon absorption of water. The change in ionic conductivity can be used in different ways, as is explained below:

Capacitor with Blocking Electrodes:

A polyelectrolyte can be used as the insulating layer in a capacitor structure, sandwiched between two blocking electrodes, configured to prevent electrochemical reactions from occurring (i.e., Faradaic reactions are negligible or are not possible). When dry, the polyelectrolyte will primarily behave as an ordinary ion-free dielectric having a capacitance proportional to the thickness of the layer. Thus, a potential applied across the electrolyte will produce a, more or less, uniform electric field within the electrolyte layer. However, when wet, the ions redistribute and, together with compensation charges in the electrodes, form electric double layers at the polyelectrolyte-electrode interfaces. Most of the applied potential will drop across these relatively thin double layers at the interfaces. As a result, the capacitance will be very high and virtually thickness independent. The change in capacitance can be as high as several orders of magnitude. The ionic conductivity of the electrolyte layer has an effect on how quickly the capacitor will charge up after applying, or changing, a voltage across the device. The higher ionic conductivity, the faster the capacitor becomes (fully) charged. The electrolyte behaves as an ordinary dielectric immediately after applying the voltage across the device. That is, the charge on the electrodes changes, and an electric field is induced inside the electrolyte. The electric field then causes the ions to redistribute and eventually further charge the electrodes by building up the electric double layers at the electrolyte-electrode interfaces. After this ionic relaxation has taken place, the electric field is high at the interfaces, but relatively small in the charge-neutral electrolyte bulk. Thus, the behavior of the capacitor is dependent on the frequency of the applied voltage. The capacitor behaves as a dielectric capacitor with low capacitance at high frequency, and as an electrolyte capacitor with high capacitance at low frequency. The ionic conductivity of the electrolyte determines the frequency range at which the transition between these two states takes place. The water content in the electrolyte can thus affect the frequency response of the capacitor.

Capacitor with Electrochemically Active Electrodes:

A polyelectrolyte used as an insulating layer in a capacitor structure with electrodes on opposite sides that can electrochemically react with ions in the electrolyte (which may be, e.g., dissociated water) will cause the device to behave in a slightly different way. When the electrolyte is dry, the device will essentially behave as an ordinary capacitor with very high DC resistance. When the electrolyte is wet or has absorbed sufficient water (in liquid or vapor form), electric double layers are formed that increase the capacitance of the electrolyte layer, but electrochemical reactions at the electrode interfaces reduce the DC resistance of the electrolyte layer. Such a device can be used as a humidity dependent resistor.

Gate Insulator in a Transistor:

The polyelectrolyte can also be used as a gate insulator material in a field-effect transistor or electrochemical transistor. The change in capacitance of the gate insulator as a function of the water content in the polyelectrolyte has a significant effect on the drain current (at a given voltage). Ideally, the transistor has a threshold voltage suitable for this configuration to work. Such a device can also be used as a variable resistor. Just as for the electrolyte capacitor, the water content in the electrolyte can have an effect on the frequency response of the transistor.

Polyanionic polyelectrolytes such as polystyrene sulfonic acid (PSSA/PSSH/PSS), polyacrylic acid (PAA), polyvinyl phosphonic acid (PVPA), and copolymers thereof can be used in organic thin film transistors (OTFTs) with good results. It is believed that such polyelectrolytes are sufficiently hygroscopic that they retain sufficient water to keep the ionic conductivity (or capacitance) at a high level, even at low relative humidity. However, the polyelectrolyte can dry out, reducing the ionic conductivity, under certain circumstances. For example, experiments have shown that an OTFT including a poly(vinyl phosphonic acid-acrylic acid) copolymer (P[VPA-AA]) polyelectrolyte, placed in an airflow with dry nitrogen (as opposed to an ambient, air-containing environment), results in the drain current dropping dramatically as compared to the same OTFT in the ambient, air-containing environment.

Referring to FIG. 3, the memory 260 in the NFC and/or RFID tag 200 may contain a fixed number of bits. In some implementations, the memory 260 in the NFC and/or RFID tag 200 may contain m*2n bits, where m is a positive integer and n is an integer of at least 3 (e.g., 24, 32, 48, 64, 128, 256 or more bits). Some bits are allocated to overhead (non-payload) data for format identification and data integrity (CRC) checking. The payload of the device 200 consumes the remainder of the bits. For example, the payload can be up to (m−p)*2ⁿ bits, where p is a positive integer <m (e.g., 96 bits in the case where m*2ⁿ=128 bits and up to 224 bits in the case where m*2ⁿ=256 bits).

The payload of the NFC and/or RFID tag 200 can be allocated to variable amounts of fixed ROM bits (which are generally—but not always—used as a unique identification number). When print methods are used in manufacturing the NFC and/or RFID tag 200, the ROM bits are permanently encoded and cannot be electrically modified. Any payload bits that are not allocated as fixed ROM bits can be allocated as dynamic sensor bits. These sensor bits can change values, based on a sensed input. Different splits or allocations between ROM and sensor bits are indicated by data format bits that are part of the non-payload or “overhead” bits, generally in the first 2ⁿ bits (or 2^{n-q} bits, where q is a positive integer <n, such as 16 bits in the case where m*2ⁿ=128 or 256) of the NFC and/or RFID tag memory 260.

One example of how sensing is implemented in the NFC and/or RFID tag 200 and memory 260 involves a chemical sensor 210 that detects when the ambient environment includes a chemical (such as water, alcohol, etc.) in a sealed package, but which can be released into the ambient environment upon opening or breaking the sealed package. Upon such an event, the sensor 210 changes state to reflect the presence of the chemical. The ROM ID bits do not change, but data integrity bits (e.g., for CRC) may be updated to reflect the state of the sensor 210. This indicates to the reader (e.g., NFC smartphone, etc.) that the protected container has been opened or otherwise compromised.

In the present application, continuity sensing generally refers to a capability and/or function that senses or determines whether a container has been opened or compromised, or remains in a closed state (e.g., its factory-sealed condition). In one embodiment, continuity sensing is implemented using one or more sensors 130, as shown in FIG. 1. As exemplified in FIG. 1, the present NFC/RF tag 100 may have three parts: the IC 110, the antenna 120, and the sensor(s) 130. The parts of the tag that include the IC 110 and antenna 120 may be anywhere on the protected product and/or package/label. The sensor(s) 130 is/are on the same part of the protected product and/or package/label as the IC 110 and antenna 120, but the sensor(s) 130 are generally relatively close to the seal and/or opening of the package or container.

For example, in certain pharmaceutical products, a container, bottle or jar may contain a drug in liquid or vapor form. The part of the tag that includes the sensor(s) 132 extends from the IC 110 on the container, bottle or jar towards the safety cap or seal, thereby being in a position to sense the presence of the liquid or vapor when the safety cap is removed or the seal is broken. When the cap is removed, the sensor 132 detects the presence of the liquid or vapor in the immediate environment, and the continuity sensor 130 and/or the IC 110 senses or determines an opened state for the container.

In a blister pack, separate sensors may extend from the IC (which may be in a region of the blister pack that is typically not opened and in which the foil or plastic film sealing the individual compartments is typically not removed easily) towards each of the respective compartments so that the sensor and IC can determine which compartments have been opened (and, in some embodiments, when each opened compartment was opened). In boxed products, a label or tape containing the NFC/RF tag can be placed near an interface between a lid and a tray, or near an interface between two flaps that meet and are taped to close and seal the box, such the sensor(s) is/are near the interface. Opening the box exposes the sensor(s) to chemical(s) therein, and a different continuity state for the container can be detected. Similar approaches and/or techniques can be applied to many different types of product containers (e.g., hinged-lid boxes for jewelry, watches, etc., alcohol bottles, cigarette packages, shipping packages such as overnight courier envelopes that can be opened by pulling a string, filament or other durable strip of material, etc.).

The present NFC/RF tag may include one or more additional and/or redundant sensors (i.e., in addition to the continuity sensor[s]). The redundant sensor(s) can be used in an “AND”-type function with the continuity sensor(s) (e.g., the IC and sensors sense that the container is opened only when all of the sensors and redundant sensors change state), or in an “OR”-type function with the sensor(s) (e.g., the IC and sensors sense that the container is opened when any of the sensors and redundant sensors change state). Alternatively, the sensor(s) and redundant sensors can provide one or more “partially-opened” continuity states when one or more of the sensors and redundant sensors change state and one or more of the sensors and redundant sensors do not change state. One skilled in the art can easily derive logic and applications for such functionality and/or capability, and redundant sensors and/or the additional sensors (when the additional sensors are or comprise a humidity sensor, temperature sensor, electromagnetic field sensor, or chemical sensor for sensing a chemical other than the chemical to be sensed by the continuity sensor[s]) can be made in the same manner and/or general structure as the continuity sensor(s).

Of course, the IC 110 in the present NFC/RF tag may include one or more sensors in addition to the continuity sensor(s) 130. For example, the IC 110 can further include one or more temperature sensors, humidity sensors (e.g., to test the humidity level of the package environment independent of the continuity sensor), electromagnetic field sensors, current/voltage/power sensors, light sensors, or other chemical sensors (e.g., for oxygen, carbon monoxide, carbon dioxide, nitrogen oxides, sulfur dioxide and/or trioxide, ozone, one or more toxins, etc.). The present IC 110 may also include one or more time sensors (e.g., configured to count or determine elapsed time), including the clock circuit 250 in FIG. 3 (which can be a basis for a real-time clock) and one or more counters, dividers, etc., as is known in the art. The leads from any external sensing mechanism should be connected to the IC 110 at terminals separate from those for the antenna 120 and the continuity sensor 130. Such sensors are generally on the same part of the package or container as the antenna 120 and the IC 110.

In this solution, the NFC feature (i.e., wireless read function) is always available, regardless of whether the product in/on which the NFC tag is integrated is in an unopened or opened state. This contrasts with traditional implementations, where the antenna is permanently broken, and the tag is therefore unreadable, after a container has been opened. In this new implementation, because the antenna lines are intact, and the continuity sensor changes state upon opening of the protected product, the NFC data will indicate to the reader (smartphone, USB reader, etc.) not only the unique ID number of that NFC and/or RFID tag (which can be used for everything from mobile marketing, customer loyalty, and discounts/cross-sell offers to supply chain tracking, tax tracking for governments, and providing specific product manufacturing information such as lot no., manufacturing date, etc.), but also whether the protected product is factory sealed/unopened (and therefore contains genuine product) or has been opened or compromised (and therefore contents are suspect if delivered to the consumer in that state). Thus, in some embodiments, it may be beneficial to locate the antenna (and optionally, the IC) a sufficient distance away from the interface between the two parts of the container to reduce or minimize the risk of inadvertent damage to the antenna (and optionally the IC) from opening the container.

By preserving the ability to read the tag both before opening and after opening (with the added dimension of reading whether the container has been opened), it is possible to continue NFC-based interaction(s) with the user after the product has been opened. For example, pharmaceuticals, cosmetics, certain alcoholic beverages, and even food products like olive oil can be opened and used for days, weeks, months, or even years. By preserving the functionality of the NFC and/or RFID tag during this time, the consumer can communicate with the manufacturer regarding the specific product bearing the NFC tag.

Applications that read NFC and/or RFID tags are generally connected to cloud servers that collect information about the IDs that are read. This is to log data for analysis and to serve the correct experience and/or provide accurate information to the consumer's smartphone or other NFC- and/or RF-capable device. When the ID indicating an ‘opened’ state is first read and processed by the cloud system, it will automatically trigger alerts (and potentially trigger investigation) if that ID is ever read again in the ‘closed’ state. That helps to ensure the integrity of the overall system. This function and/or use is not possible in traditional methods where the NFC and/or RF antenna is destroyed when the container is opened.

In addition, because the state of the NFC and/or RFID tag's data will change upon opening the protected product, NFC and/or RF devices (e.g., readers) and/or cloud systems can recognize this change in state and provide a differentiated experience when users interact with the NFC and/or RFID tag attached to the protected product or package after opening. For example, a closed product might trigger a consumer and/or user experience related to the evaluation and purchase of the product (e.g., in a retail environment), while an opened product might trigger information about how to properly use the product (e.g., by providing recipes in the case of food products, expiration dates and/or special instructions for use in the case of pharmaceutical products, etc.) and/or opportunities to instantly order related products or to reorder the same product, etc.

A more complex implementation could be used for applications in which changing the state of a continuity (protection) sensing line causes many or all bits of NFC data to be changed. This can be done in a predictable way, such as a shift, XOR or other known function, or it can be done in an unpredictable way (such as a complete replacement of a random ID with a completely different random ‘opened’ ID that is linked to the ‘closed’ ID ONLY in the private cloud database maintained by the brand owner and not accessible to the public). These functions make the tags even more difficult to copy. Of course, CRC integrity in the NFC and/or RFID tag data stream should be preserved.

A particularly high security version of this implementation involves a completely random pair of IDs, one representing ‘opened’ and one representing ‘closed’, with the association known only in the database managed by the brand owner or the manager of the protection system. This system is particularly valuable because the ‘opened’ value cannot be determined from only the ‘closed’ value, and the ‘closed’ value cannot be determined from only the ‘opened’ value. When read by the NFC phone and associated application before and after opening, the different IDs will be decoded by the cloud database to record whether that protected product is currently in the ‘opened’ or ‘closed’ state. First, that makes duplication of the IDs extremely difficult, because a set of valid ‘opened’ IDs could not be skimmed by simply systematically reading ‘closed’ stock on the shelf. Keep in mind that when scanned, the consumer will receive some information about the validity of the product. Say we have product with serial number #0210 in the field. The Closed ID is ID-A, and the Open ID is ID-B. If the cloud system receives ID-A from the system, followed by ID-B, from the same phone, it can infer that the same user opened item #0210. However, if the system receives a read of ID-A after a read of ID-B, then something is wrong because those IDs are assigned only to item #0210 and it is impossible for the ‘closed’ ID to be read after the item was permanently physically altered by breaking the sensors and shifting the NFC and/or RFID tag to the ‘opened’ ID. This could mean that an ID was cloned—and the user/brand owner/distributor/retailer (as appropriate) can be alerted and details tracked to isolate fraud and other supply chain disruptions. Such general fraud detection concepts may be similar to those used when developing rules to detect credit card fraud (e.g., a card is read in Florida, and a few minutes later is read in London, so a fraud alert is triggered).

Furthermore, the use of two completely random IDs can overcome a situation where malicious actors try to trigger IDs as ‘opened’ so as to undermine the system. This is impossible when the ‘opened’ ID cannot be easily derived from the ‘closed’ ID. This provides another layer of fraud resistance in the system.

The NFC label can be combined with tamper evident adhesives and paper for an extra layer of security. In this way, the consumer, retailer, distributor or brand representative will have a visual indication of whether the label has been tampered with.

The antenna 120 can be printed (e.g., using printed conductors such as, but not limited to, silver from a silver paste or ink) or manufactured using conventional methods like etched aluminum (e.g., by sputtering or evaporating aluminum on a substrate such as a plastic film or sheet, patterning by low-resolution [e.g., 10-1,000 μm line width] photolithography, and wet or dry etching). In order to electrically isolate the antenna coil from the continuity sensor(s) 130, the antenna 120 may be patterned on the opposite side of the substrate material from the continuity sensor(s) 130. The antenna 120 can be sized and shaped to match any of multiple form factors, while preserving compatibility with the 13.56 MHz target frequency of the NFC reader hardware.

The invention can be applied broadly to all RFID tags (not just HF/NFC/13.56 MHz tags), including RFID tags operating at frequencies higher or lower than 13.56 MHz (e.g., in the high frequency [HF] range [3-30 kHz], very high frequency [VHF] range [30-300 kHz], and ultra high frequency [UHF] range [300-3000 kHz]), especially in the case where the RFID tag has the ability or functionality to accept external sensor input(s) and communicate the same when read by an RFID reader adapted to read such a tag.

### An Exemplary Method of Making a Wireless Communication Device

The present invention also concerns a method of manufacturing a wireless communication device, comprising forming an antenna on a first substrate, forming one or more continuity sensors on a common or different substrate (i.e., the first substrate or a second, different substrate), forming an integrated circuit (IC) on a substrate, and electrically connecting (i) the antenna to a first set of terminals of the IC and (ii) the continuity sensor(s) to a second set of terminals of the IC. The IC substrate may be common with the substrate on which the antenna and/or the continuity sensor(s) are formed (i.e., the first substrate or, when present, the second substrate). Alternatively, the IC substrate may be different from the substrate on which each of the antenna and the continuity sensor(s) are formed (i.e., a second substrate when the antenna and the sensor[s] are formed on the same [e.g., first] substrate, or a third substrate when the antenna and the sensor[s] are formed on different substrates). The antenna is configured to receive and/or transmit or broadcast a wireless signal.

In various embodiments, the wireless communication device comprises a near field or radio frequency communication device. In one example, the device is an NFC device, such as an NFC tag.

Some embodiments of the method of making a wireless communication device may comprise making a plurality of continuity sensors. Additionally or alternatively, the method may further comprise forming one or more redundant continuity sensors, as described herein. The redundant continuity sensor(s) may be formed on the same substrate as the continuity sensor(s).

In the present method of making a wireless communication device, forming the integrated circuit may comprise printing one or more layers of the integrated circuit. Printing offers advantages over photolithographic patterning processes, such as low equipment costs, greater throughput, reduced waste (and thus, a “greener” manufacturing process), etc., which can be ideal for relatively low transistor-count devices such as near field, RF and HF tags. Thus, in some cases, the method may comprise printing a plurality of the layers of the integrated circuit. Printing various layers (and in one example, all of the layers) of the wireless communication device facilitates integration of the method of making into existing high-speed, high-throughput manufacturing processes, such as roll-to-roll processing.

Alternatively, the method may form the integrated circuit by a process that comprises forming a plurality of layers of the integrated circuit by one or more thin film processing techniques. Thin film processing also has a relatively low cost of ownership, and is a relatively mature technology, which can result in reasonably reliable devices being manufactured on a wide variety of potential substrates. In some embodiments, the best of both approaches can be used, and the method may form one or more layers of the integrated circuit by one or more thin film processing techniques, and printing one or more additional layers of the integrated circuit.

In some embodiments, forming the antenna may consist of forming a single metal layer on the first substrate, and etching the single metal layer to form the antenna. Alternatively, forming the antenna may comprise printing a metal ink on the first substrate in a pattern corresponding to the antenna. In some relatively advantageous embodiments, the antenna consists of a single common metal layer on a common substrate, and the IC is formed or made in a manner enabling the IC to function as a strap or bridge between the terminals of the antenna, and thus electrically connect the terminals of the antenna to the IC. This allows for use of an antenna that consists of a single patterned metal layer.

As described herein, the tag generally comprises an integrated circuit and a continuity sensor. Consequently, electrically connecting the continuity sensor(s) to the integrated circuit (IC) comprises electrically connecting the continuity sensor(s) to a set of terminals on or in the IC. Furthermore, the integrated circuit may further comprise a threshold comparator configured to receive an output of the sensor, a memory including one or more bits configured to store a value corresponding to a continuity state of the container or package, and/or any of the other circuits or circuit blocks disclosed herein. For example, the memory may include a plurality of bits configured to store a unique identification code for the container or package. In such a case, forming the memory may comprise printing at least one layer of the memory that includes the plurality of bits configured to store the unique identification code (e.g., to form a hard-wired ROM, similar to a mask ROM).

### An Alternative Wireless Communication Device with One or More Sensors

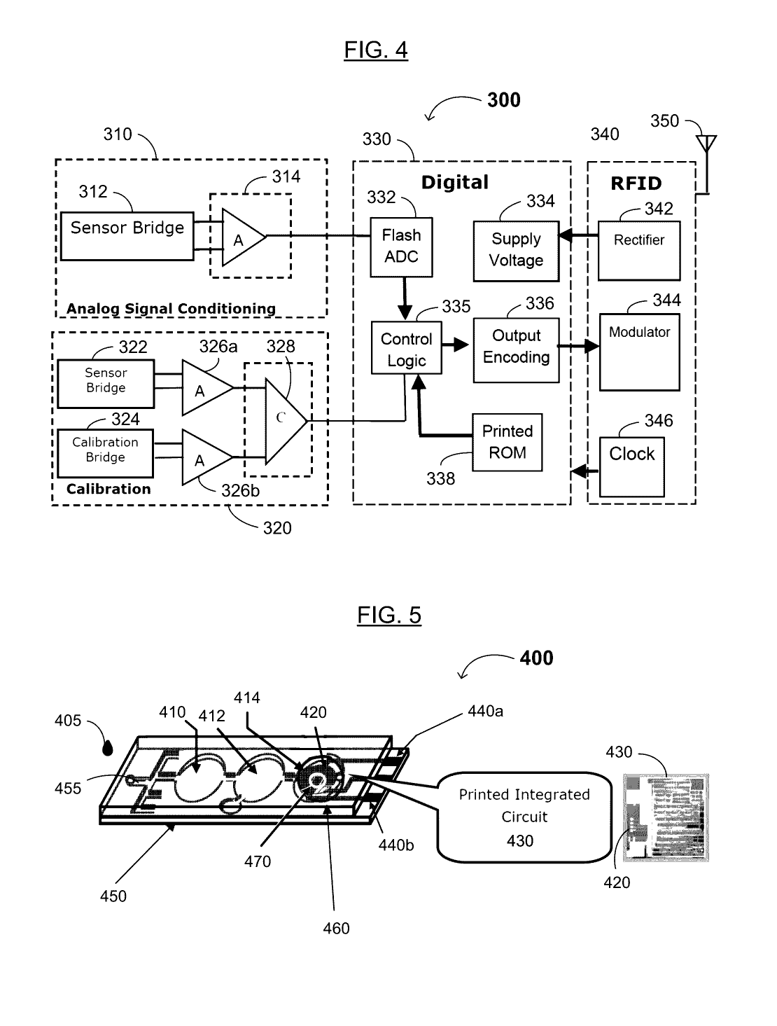

FIGS. 4-5 show a wireless communication device 300, 400 (e.g., an NFC or RFID tag) with one or more continuity sensor elements or sensor arrays, one or more sensor interface circuits, and an integrated circuit coupled to one or more antennas 350, 440 for communicating with a wireless reader. In some embodiments, the wireless communication device 300, 400 may further comprise an integrated display.

A sensor with multiple sensor elements (or sensor arrays) can be used for the detection of multiple chemical species, a chemical species and one or more environmental parameters such as temperature, humidity or brightness (light), or as redundant sensors for the detection of the same chemical species. Tailored passivation layers can enhance sensor specificity. Thus, the multiple sensor array can include multiple copies of the same sensor or different types of sensors, as may be desired for a given application.

Examples of additional chemical sensors the properties of which change upon absorption of the chemical can include hydrogels and/or dry gels with a physical matrix that contains one or more analyte-sensitive fluorophores or electrophores (e.g., an alcohol-sensitive fluorophore) dispersed therein. More specifically, examples of such chemical sensors include analyte-sensitive fluorophores in a sol-gel matrix or film, and thermochemical sensors (the temperature of which changes upon a reaction with the analyte, or with the chemical or substance in the container, in which the temperature change is determined by calorimetry).

It may also be desirable to print different sections of an individual sensor element with different types of metal-specific seed layers, then plate different metals (e.g., Pd, Au, Ag, etc.) on the different seed layers. For example, this approach provides part of the sensor element with a Pd electrode/sensor element and part with an Au or Ag electrode/sensor element, in essence creating a multisensor array within a sensor element. This also provides unique current signatures, for example, depending on the reaction or binding of the chemical species with or to different metals, and the amount or relationship(s) of the different metals in the sensor element.

Integrating a sensor 312 with a local amplifier 314 and\or other analog signal conditioning circuit(s) (e.g., temperature compensation, drift, offset, etc.) as shown in FIG. 4 can increase sensor performance by improving, e.g., the signal-to-noise ratio, resulting in a lower rate of false positive results. By using multiple sensor elements 312 and 322, coupled to a local comparator 328 as shown in the calibration block of FIG. 4, each individual continuity sensor 310 can be calibrated on-board, rather than using conventional lot calibration methods. By comparing a control value or a control sensor element 324 with actual readings, the comparator 328 (which receives amplified outputs from the redundant sensor 322 and the calibration value or bridge 324 via amplifiers 326a-b) can also be used as a built in expiration mechanism for the product(s) within the labeled packaging.

The coupling of the continuity sensor interface circuit (e.g., including amplifier 314) to an analog-digital converter (ADC) 332 as shown in the digital logic block 330 of the interface circuit 300 allows continuity sensor data to be transmitted via NFC or RF wireless communication protocol(s) using control logic 335, encoder 336 and modulator 344. By integrating the NFC, RF and/or RFID function(s) onto the tag 300, any NFC or RF signal-based reader or device (e.g., an NFC-enabled smart/cellular phone or tablet computer) can be used to send sensor results to anyone. By using such an NFC- or RF-enabled device 300, a wireless internet data management system (without the need for an additional sensor reader) is possible. In addition, an on-board ROM 338 can be printed (in part or in its entirety) and/or placed in or on the IC to provide a unique ID, eliminating possible human transcription and/or sample ID errors, as well as providing an anti-counterfeit ID (see, e.g., U.S. patent application Ser. No. 11/544,366, filed on Oct. 6, 2006 [Attorney Docket No. IDR0642], and U.S. Pat. No. 8,758,982 [Attorney Docket No. IDR0602], the relevant portions of which are incorporated herein by reference).

The ADC 332 may be or comprise a flash ADC (or direct-conversion ADC) that, in turn, comprises a linear or non-linear voltage ladder with a comparator at each step or “rung” of the voltage ladder to compare the input voltage from the amplifier 314 to successive reference voltages. The wireless communication device 300 further comprises a rectifier 342 configured to rectify the wireless signal received by or at the antenna 350 and provide the rectified signal to a supply voltage block or circuitry 334 in the digital block 330, and a clock or timing circuit 346 in the wireless interface (e.g., RF or RFID) block 340. In one embodiment, the clock/timing circuit 346 comprises a clock or clock-data recovery circuit. Such clock or clock-data recovery circuits are well known to those skilled in the art.

FIG. 5 shows an exemplary multi-sensor tag 400, comprising sensors 410, 412 and 414, a printed integrated circuit 430 on or over the third sensor 414, and an antenna or antenna connections 440a-b, all on a substrate 450. At least one of the first and second sensors 410 and 412 is the present continuity sensor. The second sensor 412 may be a redundant or additional sensor, and the third sensor 414 may be an additional sensor, as described herein. When the first sensor 410 is a continuity sensor, it may detect the presence of a substance 405 from within packaging or bottling (not shown). As shown in FIG. 5, the substance 405 may be wine or spirits, and when the bottle containing such a substance is opened, a small amount (e.g., a droplet having a volume of from 0.1-50 microliters) is dispersed onto the device 400 (e.g., onto the first sensor 410 or a channel 455 that feeds the droplet onto the sensor 410). The sensors 410, 412 and 414 provide output signals to a detection protocol section 420 of the printed integrated circuit 430 for processing by the printed integrated circuit 430 as described herein. Optionally, the printed integrated circuit 430 may include a comb electrode 470 configured to independently receive the different outputs from the different sensors.

It is also envisioned that a printed display (using TFT technology as described in U.S. Pat. Nos. 7,687,327, 7,701,011, 7,767,520 and/or 8,796,125 [Attorney Docket Nos. IDR0502, IDR0743, IDR0742 and IDR0813, respectively], the relevant portions of which are incorporated herein by reference) can be integrated into the tag, thereby enabling the tag to display the continuity sensor results without the need for a sensor reader. For example, the printed display may be an electrochromic display. The TFT technology described in U.S. Pat. Nos. 7,687,327, 7,701,011, 7,767,520 and/or 8,796,125 can also be used to form the integrated circuit, a rectifier (e.g., for powering the tag from a wireless signal from the reader), and/or circuitry and/or traces in the continuity sensor.

An advantage of printing circuitry on such a tag 300, 400 is that the continuity sensor element(s) and the antenna can be printed simultaneously on the same substrate in a single step (or same set of steps, if the printing process includes multiple steps). This is expected to greatly increase the efficiency of manufacturing such tags.

### An Exemplary Method of Using a Wireless Communication Device to Detect an Opened or Compromised Package or Container

The present invention further concerns a method of detecting an opened or compromised package or container, comprising placing a wireless communication device comprising an antenna, one or more continuity sensors, and an integrated circuit electrically connected to each of the antenna and the continuity sensor(s) on the package or container, and sensing a continuity state of the package or container using the continuity sensor(s) and the integrated circuit. In various embodiments, the wireless communication device comprises a near field and/or radio frequency communication device, such as an NFC tag.

As described herein, the package or container has first and second separable parts, and the wireless communication device may be placed on the package or container such that at least one continuity sensor is near an interface between the first and second separable parts of the package or container. This maximizes the probability that the continuity sensor(s) will detect at least one chemical component inside the package or container upon opening the package or container, or the package or container becoming damaged or compromised. Thus, the continuity state of the package or container may be “opened” when at least one sensor near the interface between the separable parts of the package or container detects a chemical that is known to be inside the package or container. Similarly, the continuity state of the package or container may be “closed” or “sealed” when the sensor(s) does not detect a chemical component known to be inside the package or container (e.g., at a level or concentration above that expected to be in the environment of the package or container).

As for other aspects of the invention, the wireless communication device may comprise a plurality of the continuity sensors and/or one or more redundant continuity sensors. In such embodiments, the package may be considered opened when one of the continuity sensors detects at least one chemical component inside the package or container, when all of the continuity sensors detect at least one chemical component inside the package or container, or when any number of continuity sensors between one and all of the continuity sensors detect at least one chemical component inside the package or container. Furthermore, in a multi-compartment package such as a blister pack, each of the plurality of continuity sensors may be near a unique one of the multiple sealed or closed compartments of the package. When the wireless communication device includes one or more redundant continuity sensors, the redundant continuity sensor(s) may be on the same substrate as the continuity sensor(s).

As described elsewhere herein, the integrated circuit may comprise one or more printed layers, a plurality of thin films, or one or more thin films and one or more printed layers. The antenna may consist of single metal layer.

The integrated circuit may further comprise a threshold comparator receiving an output of the continuity sensor, a memory including one or more bits configured to store a value corresponding to the continuity state of the container or package, and/or any other circuit or circuit block disclosed herein. In some examples, the memory includes a plurality of bits configured to store a unique identification code for the container or package. In such examples, the memory may comprise at least one printed layer in the plurality of bits configured to store the unique identification code.

### An Exemplary Communication System Employing the Exemplary Wireless Tag

The present invention may further concern an exemplary system configured to wirelessly communicate information about a product in an opened or unopened package or container, comprising reading a tag on the package or container with a wireless tag reader (e.g., a device such as an NFC- or RF-enabled smart phone or tablet computer), sensing a continuity state of the package or container (e.g., using a continuity sensor on the tag), and displaying information about the product on the wireless tag reader. In various embodiments, the tag is a near field and/or radio frequency communication device, such as an NFC tag, and comprises an antenna, one or more continuity sensors, and an integrated circuit electrically connected to each of the antenna and the continuity sensor(s). When the continuity sensor(s) determine that the package or container is unopened, the wireless tag reader displays a first set of information, and when the continuity sensor(s) determine that the package or container is opened, the wireless tag reader displays a second set of information different from the first set of information. In either case (i.e., when the continuity sensor[s] determine that the package or container is opened or unopened), the wireless tag reader may display additional information (i.e., in addition to first or second set of information) that can be the same, regardless of whether the package or container is determined to be opened or unopened.

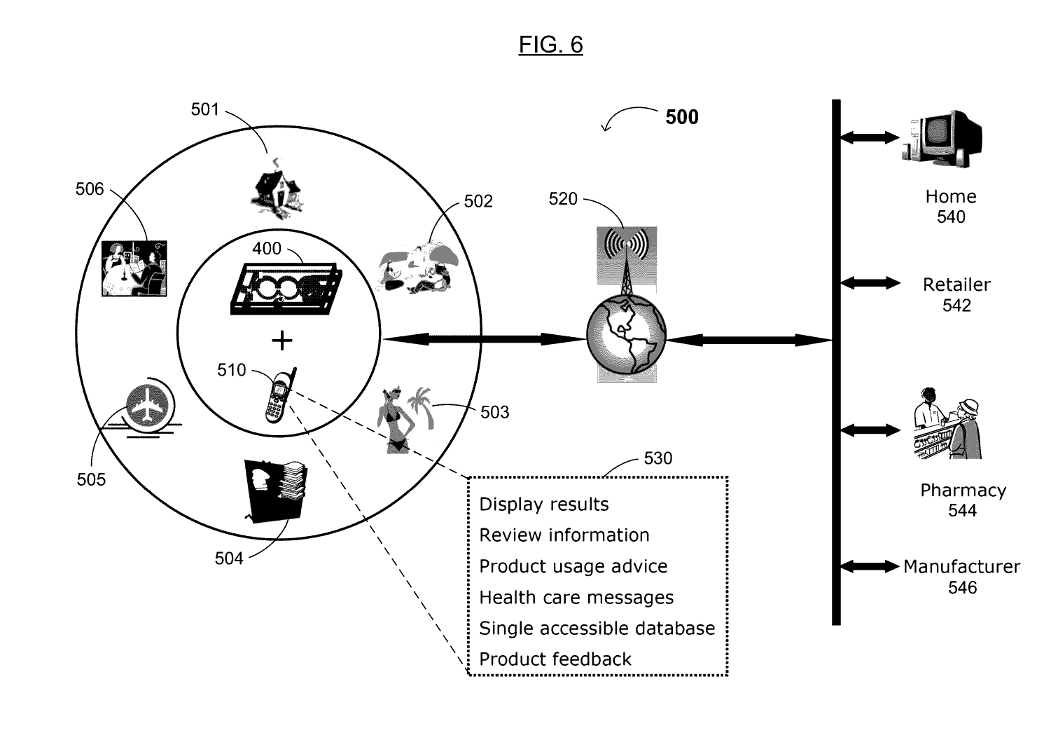

Referring to FIG. 6, the wireless communication device 400 with the continuity sensor therein can be placed on a container or packaging in any environment, such as the home 501, the outdoors 502, a vacation location (e.g., the beach) 503, the office or other business location 504, a travel or shipping location (e.g., an airport or plane) 505, an entertainment location (e.g., a restaurant) 506, etc. The NFC- or RF-enabled mobile device 510 reads the wireless communication device 400 and, among other information 530, displays results of the sensor processing operations. Optionally, the mobile device 510 can display information about the product inside the container or packaging to which the device 400 is attached or affixed for the user of the mobile device 510 to review. Such information may include the product identity, amount (e.g., volume or weight), price, expiration date, lot number, manufacturer, etc. The mobile device 510 can also communicate over the network with the a home network 540, a retailer 542, a medical or other service provider (e.g., a pharmacy) 544, and/or the product manufacturer 546 to obtain additional information 530, such as product usage advice, health care information and/or messages, information from a database (which can be, in one example, a single accessible database), etc. The mobile device 510 can also enable the user to provide product feedback to the retailer 542, service provider 544 and/or manufacturer 546, as well as provide information to the database, over the network 500.

In one embodiment, the communications network 500 in FIG. 6 is a publicly accessible communications network. In another embodiment, the communications network 500 is a private network or is a hybrid network having both public and private portions or domains. In either case, the sensor network architecture includes one or more NFC- and/or RF-enabled tags 400 with sensors therein, and one or more wireless sensor readers 510 coupled to the communications network.

The wireless tag reader (e.g., the mobile phone 510 in FIG. 6) communicates with the communications network 500 via a wireless (e.g., air) interface. The communications network 500 can also be connected to the Internet 520, thus providing worldwide access. In another aspect of the invention, the wireless tag reader 510 can incorporate geolocation data along with continuity sensor data and unique ID data to the communications network 500. Still in another aspect of the invention, the unique ID data can be used to validate tag authenticity for anti-counterfeiting (see, e.g., U.S. patent application Ser. No. 11/544,366 [Attorney Docket No. IDR0642], filed on Oct. 6, 2006, and U.S. Pat. No. 8,758,982 [Attorney Docket No. IDR0602], the relevant portions of which are incorporated herein by reference).

The tags 400 for use in the network 500 combine NFC and/or RFID functionality with a continuity sensor. The tag 400 further includes one or more antennas (not shown in FIG. 6) for communication with the wireless sensor reader 510, one or more optional additional sensors, an RF and/or near field power and communications interface, and a sensor interface circuit. In some embodiments, all of these components are formed on the same substrate.

According to aspects of the communication network 500, the wireless tag reader 510 includes one or more antennas, a user interface, a display, a network communications module, and a RFID or near field communications reader. The network communications module is configured to provide communication with the communications network. The wireless tag reader is implemented in a wireless device, such as a smart phone, tablet computer, wireless communications device in an automobile or other vehicle, or laptop computer.

Deployment of a network configured to communicate information about a product, the packaging of which has the present NFC and/or RF tag thereon, over a large geographical area for continuous, real-time monitoring and detection of packaging continuity, as well as obtaining information about product contents and use, product expiration and reordering, and related or complementary products is possible. The present invention enables large scale deployment over a large geographic area of multiple sensors using the existing mobile phone communications network and the Internet to collect and cross-validate identification and/or security data, while at the same time providing real time product and geolocation information.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application. It is intended that the scope of the invention be defined by the claims appended hereto and their equivalents.

What is claimed is:

1. A wireless communication device, comprising:
a) a receiver and/or transmitter;
b) a substrate with an antenna thereon, said antenna receiving a first wireless signal and/or transmitting or broadcasting a second wireless signal;
c) an integrated circuit configured to (i) process said first wireless signal and/or information therefrom, and/or (ii) generate said second wireless signal and/or information therefor, said integrated circuit having a first set of terminals electrically connected to said antenna; and
d) one or more continuity sensors on a common or different substrate, the continuity sensor(s) comprising (i) a chemical sensor configured to sense or determine a presence of material in a package or container on which the communication device is placed or to which the communication device is fixed or adhered, and (ii) a trace electrically connecting the chemical sensor to a second terminal of said integrated circuit different from said first set of terminals.

2. The wireless communication device of claim 1, wherein the continuity sensor(s) comprise a trace with a section therein including a material having a conductance or resistivity that changes based on exposure to a chemical or substance inside the package or container.

3. The wireless communication device of claim 1, wherein the continuity sensor(s) comprise a transistor with a gate or base including a material having a conductance or resistivity that changes based on exposure to a chemical or substance inside the package or container.

4. The wireless communication device of claim 1, wherein the integrated circuit further comprises a second sensor electrically connected to said integrated circuit at a third set of terminals different from said first and second sets of terminals.

5. The wireless communication device of claim 1, wherein the integrated circuit further comprises a memory including one or more bits configured to store a value corresponding to a continuity state of the container or package.

6. The wireless communication device of claim 5, wherein the memory includes a plurality of bits configured to store a unique identification code for the container or package.

7. The wireless communication device of claim 1, further comprising one or more redundant continuity sensors.

8. The wireless communication device of claim 1, wherein said substrate comprises a plate, disc and/or sheet of a glass, ceramic, dielectric and/or plastic.

9. A package or container, comprising:
a) first and second separable parts with an interface therebetween; and
b) the wireless communication device of claim 1, on one of the first and second separable parts of the package or container, wherein the continuity sensor(s) is near the interface.

10. The package or container of claim 9, wherein the continuity sensor(s) is configured to determine a presence of a chemical or substance in the package or container.

11. The package or container of claim 10, wherein the package or container is considered open when the continuity sensor(s) determines the presence of the chemical or substance, and the package or container is considered sealed when the continuity sensor(s) does not determine the presence of the chemical or substance.

12. A method of manufacturing a wireless communication device, comprising:
a) forming an antenna on a first substrate, said antenna being configured to receive and/or transmit or broadcast a wireless signal;
b) forming one or more continuity sensors on a common or different substrate;
c) forming an integrated circuit on a substrate common with at least one of the antenna and the continuity sensor(s), or different from each of the antenna and the continuity sensor(s); and
d) electrically connecting the antenna to a first set of terminals of the integrated circuit, and the continuity sensor(s) to a second set of terminals of the integrated circuit.

13. The method of claim 12, further comprising forming a trace in the continuity sensor(s), the trace having a section therein including a material having a conductance or resistivity that changes based on exposure to a chemical or substance inside the package or container.

14. The method of claim 12, wherein forming the integrated circuit comprises printing one or more layers of the integrated circuit.

15. The method of claim 12, wherein forming the integrated circuit comprises forming a plurality of layers of the integrated circuit by one or more thin film processing techniques, and optionally, printing one or more additional layers of the integrated circuit.

16. The method of claim 12, wherein forming the antenna comprises printing a metal ink on the first substrate in a pattern corresponding to the antenna.

17. The method of claim 12, wherein forming the integrated circuit further comprises forming a memory including (i) one or more bits configured to store a value corresponding to a continuity state of the container or package and (ii) a plurality of bits configured to store a unique identification code for the container or package.

18. A method of detecting an opened package or container, comprising:
a) placing a wireless communication device comprising an antenna, one or more continuity sensors, and an integrated circuit electrically connected to each of the antenna and the continuity sensor(s) on the package or container such that at least one of the continuity sensor(s) is near an interface between first and second separable parts of the package or container; and
b) using the integrated circuit and the at least one continuity sensor, sensing a continuity state of the package or container.

19. The method of claim 18, wherein the continuity sensor(s) comprises a trace having a section therein including a material having a conductance or resistivity that changes based on exposure to a chemical or substance inside the package or container.

20. The method of claim 19, wherein the continuity state of the package or container is opened when the continuity sensor(s) determine a presence of a chemical or substance in the package or container, and the continuity state of the package or container is closed or sealed when the continuity sensor(s) does not determine the presence of the chemical or substance.
